(19) United States
(12) Patent Application Publication
(10) Pub. No.: US 2014/0062915 A1
(43) Pub. Date: Mar. 6, 2014

(54) TOUCHSCREEN PANEL AND TOUCHSCREEN DEVICE

(71) Applicant: SAMSUNG ELECTRO-MECHANICS CO., LTD., Suwon (KR)

(72) Inventors: Hyun Jun KIM, Suwon (KR); Tah Joon Park, Suwon (KR)

(73) Assignee: SAMSUNG ELECTRO-MECHANICS CO., LTD., Suwon (KR)

(21) Appl. No.: 13/850,388

(22) Filed: Mar. 26, 2013

(30) Foreign Application Priority Data
Sep. 5, 2012 (KR) 10-2012-0098445

(51) Int. Cl. G06F 3/041

(52) U.S. Cl. CPC G06F 3/041
USPC 345/173

(57) ABSTRACT

There are provided a touchscreen panel and a touchscreen device, the touchscreen panel including: a plurality of first electrodes each including a base portion extended in a first axis direction and one or more branch portions connected to the base portion; and a plurality of second electrodes each extended in a second axis direction intersecting the first axis direction, wherein the branch portions may be extended from an intersection between the base portion of the first electrode and the second electrode.

### CROSS-REFERENCE TO RELATED APPLICATIONS

This application claims the priority of Korean Patent Application No. 10-2012-0098445 filed on Sep. 5, 2012, in the Korean Intellectual Property Office, the disclosure of which is incorporated herein by reference.

### BACKGROUND OF THE INVENTION

1. Field of the Invention

The present invention relates to a touchscreen panel and a touchscreen device.

2. Description of the Related Art

A touch sensing device, such as a touchscreen, a touch pad, or the like, is an input device attached to a display device to provide an intuitive input method to a user. Recently, various electronic apparatuses, such as mobile phones, personal digital assistants (PDAs), navigation systems, and the like, have been widely used. Especially, as demand for smart phones has increased in recent years, the touchscreen has been increasingly adopted as a touch sensing device capable of providing various input methods in a restricted form factor.

Touchscreens applied to mobile apparatuses may be largely classified as resistive-type touchscreens and capacitive-type touchscreens depending on the method of sensing touch input thereof. Capacitive-type touchscreens have been increasingly applied to mobile apparatuses, due to advantages thereof, such as a relatively long lifespan and easy implementation of various input methods and gestures therein.

In particular, capacitive-type touchscreens allow for easier implementation of a multi-touch interface as compared with resistive-type touchscreens, and thus are widely applied to apparatuses such as smart phones and the like.

The capacitive-type touchscreens includes a plurality of electrodes having a predetermined pattern. In the capacitive-type touchscreens, electrodes need to be formed in a majority of a touchscreen area, which corresponds to an effective display area of the display device. As a representative example of a capacitive-type touchscreen panel, there is provided a bar and stripe two-layer structure. With respect to an upper stripe electrode, the width thereof is reduced by as much as possible based on the resistance limit thereof, in order to secure strong touch strength. With respect to a lower bar electrode, the width thereof may be increased by as much as possible in order to protect the upper stripe electrode from noise generated from an LCD provided in a lower plate.

However, in the case in which the lower bar electrode is relatively wide, noise in the lower bar electrode itself may be increased, and thus an effect thereof on the upper stripe electrode may be increased. Also, as a gap between the upper and lower electrodes becomes closer, capacitance between intersecting electrodes maybe increased, resulting in reducing the rate of change in the capacitance, and thus there is a limit in slimming the touchscreen panel.

### RELATED ART DOCUMENTS

(Patent Document 1) Korean Patent Laid-Open Publication No. 2011-0113035
(Patent Document 2) Korean Patent Laid-Open Publication No. 2011-0120056

### SUMMARY OF THE INVENTION

An aspect of the present invention provides a capacitive-type touchscreen device and a touchscreen panel, capable of being slimmed through a width of a first electrode being equal to or smaller than width of a second electrode, and capable of having an increased rate of change in capacitance even in the case that the width of the first electrode is small, by forming branch portions at the first electrode.

According to an aspect of the present invention, there is provided a touchscreen panel, including: a plurality of first electrodes each including a base portion extended in a first axis direction and one or more branch portions connected to the base portion; and a plurality of second electrodes each extended in a second axis direction intersecting the first axis direction, wherein the branch portions may be extended from an intersection between the base portion of the first electrode and the second electrode.

The touchscreen panel may further include a third electrode formed between one first electrode and another first electrode adjacent thereto among the plurality of first electrodes, the third electrode being grounded.

Here, a portion of the first electrode and a portion of the second electrode may be included in a single unit sensing cell being square, and the branch portions included in the unit sensing cell may be extended in diagonal directions in the unit sensing cell.

The branch portions included in the unit sensing cell, may be spaced apart from branch portions included in another unit sensing cell adjacent to the unit sensing cell.

The branch portions may be symmetrical to each other with respect to the first axis direction and the second axis direction, centered on the intersection between the first electrode and the second electrode.

Here, distal ends of the branch portions may be parallel with the first axis direction and the second axis direction.

Here, the base portion of the first electrode may have a width equal to or less than that of the second electrode.

The touchscreen panel may further include an operating unit determining a touch input by sequentially applying predetermined driving signals to the plurality of respective first electrodes and detecting changes in capacitance from the plurality of second electrodes intersecting the first electrodes to which the driving signals are applied.

According to another aspect of the present invention, there is provided a touchscreen device, including: a panel unit including a plurality of first electrodes each extended in a first axis direction and a plurality of second electrodes each extended in a second axis direction intersecting the first axis direction; and an operating unit electrically connected to the plurality of first electrodes and the plurality of second electrodes to determine a touch input, wherein the first electrode may include abase portion extended in the first axis direction and branch portions connected to the base portion, and the branch portions may be extended from an intersection between the base portion of the first electrode and the second electrode.

The panel unit may include a plurality of unit sensing cells each being square and including the first electrode the second electrode intersecting each other at a center of the square.

The first electrode and the second electrode included in one unit sensing cell are connected to the first electrode and the second electrode included in another unit sensing cell adjacent thereto among the plurality of unit sensing cells.

The branch portions of the first electrode included in the unit sensing cell may be extended from the center of the square in diagonal directions.

The branch portions may be symmetrical to each other with respect to the first axis direction and the second axis direction, centered on the center of the square.

Here, distal ends of the branch portions extended from the center of the square in the diagonal directions may be parallel with the second electrode.

The operating unit may determine a touch input by applying a predetermined driving signal to the first electrodes and detecting changes in capacitance from the second electrodes.

The operating unit may determine at least one of coordinates of the touch input, a gesture motion due to the touch input, and the number of touch inputs.

The panel unit may further include a third electrode formed between one first electrode and another first electrode adjacent thereto among the plurality of first electrodes, the third electrode being grounded.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing an external appearance of an electronic apparatus including a touchscreen device according to an embodiment of the present invention;

FIG. 2 is a plane view of a touchscreen device according to an embodiment of the present invention;

FIG. 3 is a view for illustrating a unit sensing cell of the touchscreen device according to the embodiment of the present invention;

FIG. 4 is a view for illustrating an operation of the touchscreen device according to the embodiment of the present invention; and

FIG. 5 is a schematic diagram showing the touchscreen device according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

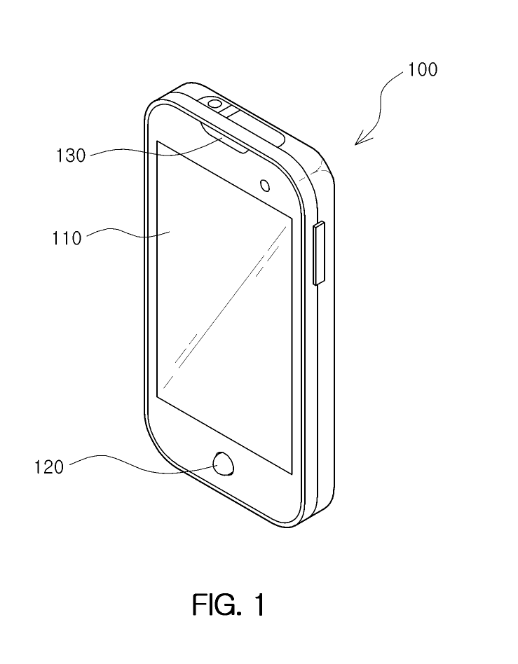

FIG. 1 is a perspective view showing an external appearance of an electronic apparatus including a touchscreen device according to an embodiment of the present invention.

FIG. 1 is a view showing an electronic apparatus to which a touch sensing device according to an embodiment of the present invention may be applied. Referring to FIG. 1, an electronic apparatus 100 according to the present embodiment may include a display device 110 for outputting a screen therethrough, an input unit 120, an audio unit 130 for outputting a sound and the like, and may be integrated with the display device 110 to provide the touch screen apparatus.

As shown in FIG. 1, in general, a mobile device may be configured in such a manner that a touch screen apparatus is integrated with a display device, and the touch screen apparatus may have a high degree of light transmissivity to which an image passes through a screen displayed on the display device. Thus, the touch screen apparatus may be manufactured by forming a sensing electrode on a base substrate formed of a transparent film material such as polyethylene terephthalate (PET), polycarbonate (PC), polyethersulfone (PES), polyimide (PI) or the like and the sensing electrode is formed of an electrically conductive material such as indium-tin oxide (ITO), indium zinc oxide (IZO), zinc oxide (ZnO), carbon nanotubes (CNT), a conductive polymer, or graphene. In the present embodiment, the sensing electrode may be formed in a mesh structure in which metals having a very thin line width are densely disposed. A wiring pattern connected to the sensing electrode formed of a transparent conductive material is formed in a bezel region of the display device. Since the wiring pattern is visually shielded by the bezel region, the wiring pattern may also be formed of a metal such as silver (Ag), copper (Cu), or the like.

Certainly, in the case in which the touch sensing device according to the present invention is not provided integrally with a display device, such as a touch pad of a notebook computer, the sensing electrodes may be fabricated by simply patterning metals on a circuit board. However, for convenience of explanation, the touch sensing device and a touch sensing method according to the present invention will be described based on a touchscreen device.

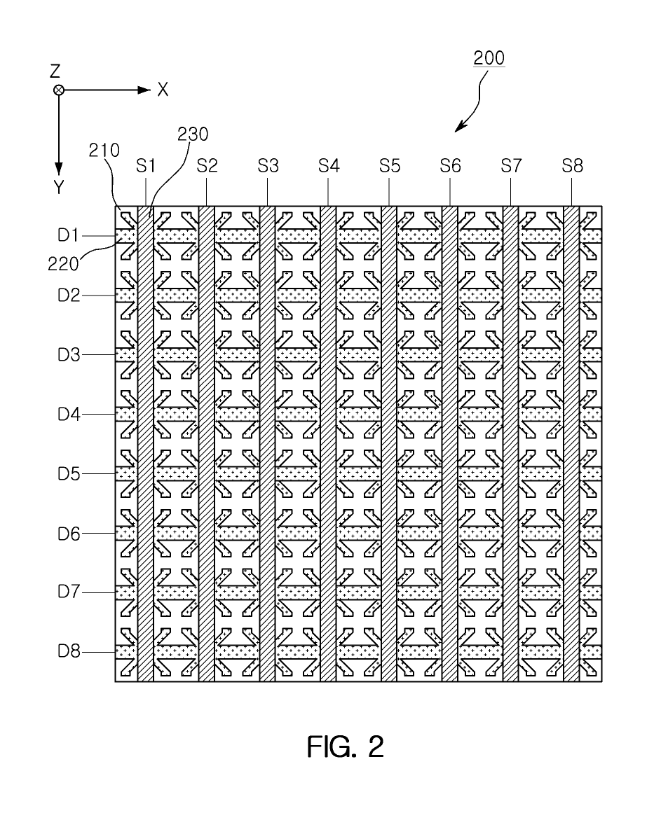

FIG. 2 is a plane view showing a touchscreen panel according to an embodiment of the present invention.

Referring to FIG. 2, a touchscreen panel 200 according to the present embodiment may include a substrate 210, a plurality of first electrodes 220, a plurality of second electrodes 230, and a third electrode (not shown), provided on the substrate 210. Although not shown in FIG. 2, the plurality of first and second electrodes 220 and 230 may be electrically connected with wiring patterns of a circuit board, which is bonded to one end of the substrate 210, through wirings and bonding pads. A controller integrated circuit is mounted on the circuit board to detect a sensing signal generated from the plurality of first and second electrodes 220 and 230 and determine a touch input therefrom.

In the case of a touchscreen device, the substrate 210 may be a transparent substrate for forming the first and second electrodes 220 and 230 thereon, and may be formed of a plastic material such as polyimide (PI), polymethylmethacrylate (PMMA), polyethyleneterephthalate (PET), or polycarbonate (PC), or a tempered glass. In addition, with respect to a region in which the wirings connected with the plurality of first and second electrodes 220 and 230 are formed, except for the region in which the plurality of first and second electrodes 220 and 230 are formed, a predetermined printing region may be formed on the substrate 210 in order to visually shield the wirings which are generally formed of an opaque metal material.

The plurality of first and second electrodes 220 and 230 may be provided on one surface or both surfaces of the substrate 210. In the case of the touchscreen device, the first and second electrodes may be formed of indium tin-oxide (ITO), indium zinc-oxide (IZO), zinc oxide (ZnO), carbon nano tube (CNT), a graphene based material, or the like, having transparency and conductivity.

The plurality of first electrodes 220 may be extended in an X-axis direction, and the plurality of second electrodes 230 may be extended in a Y-axis direction.

The first electrodes 220 and the second electrodes 230 may intersect each other on both surfaces of the substrate 210, or on different substrates 210. In the case in which the first electrodes 220 and the second electrodes 230 are all provided on one surface of the substrate 210, predetermined insulating layers may be partially formed in intersections between the first electrodes 220 and the second electrodes 230.

The controller integrated circuit, which is electrically connected with the plurality of first and second electrodes 220 and 230 to sense a touch input, may detect changes in capacitance generated from the plurality of first and second electrodes 220 and 230 by the touch input and sense the touch input therefrom. The first electrodes 220 may be connected to channels D1-D8 in the controller integrated circuit, to receive a predetermined driving signal therefrom. The second electrodes 230 may be connected to channels S1-S8 in the controller integrated circuit to thereby allow the touch sensing device to detect a sensing signal. Here, the controller integrated circuit may detect, as a sensing signal, changes in mutual-capacitance generated between the first electrodes 220 and the second electrodes 230, and may be operated in such a manner that driving signals are sequentially applied to the respective first electrodes 220 and the changes in capacitance are simultaneously detected by the second electrodes 230.

The plurality of first electrodes 220 each may include a base portion extended in the X-axis direction, and branch portions connected to an upper portion or a lower portion of the base portion. The branch portions may be extended from the intersection between the first electrode 220 and the second electrode 230 in diagonal directions. However, the branch portions of one first electrode 220 may not be connected to the branch portions of another first electrode 220 adjacent thereto, among the plurality of the first electrodes 220.

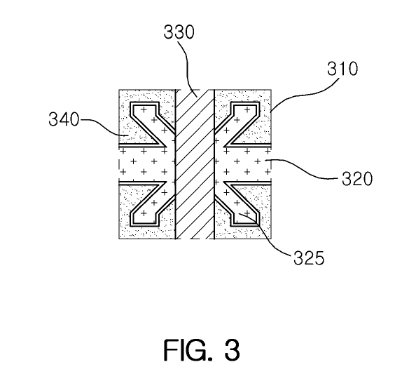

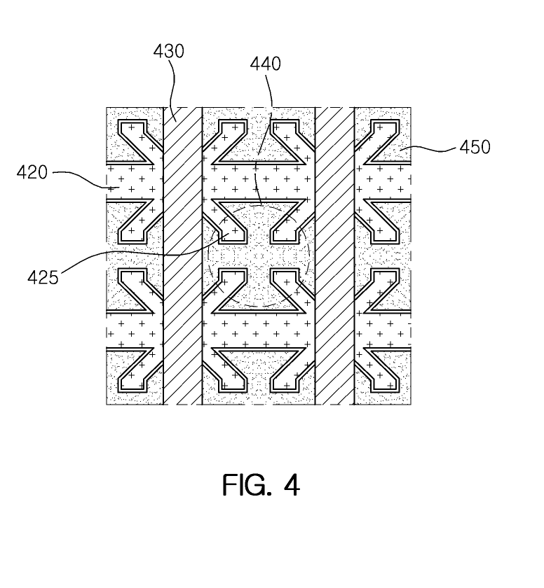

Although not shown in the drawing, the third electrode may be connected with a ground terminal. The third electrode may be formed between one first electrode and another first electrode adjacent thereto among the plurality of first electrodes, and may have a shape interlocking with the first electrodes. Hereinafter, the third electrodes will be specifically described with reference to FIGS. 3 and 4.

FIG. 3 is a view for illustrating a unit sensing cell of the touchscreen device according to the embodiment of the present invention.

Referring to FIG. 3, a unit sensing cell 310 including a portion of first electrodes 320 and 325 and a portion of second electrode 330 may be defined. The unit sensing cell 310 may be square as shown in FIG. 3, and may include the portions of the first electrodes 320 and 325 and the second electrode 330 such that an intersection between the first electrodes 320 and 325 and the second electrode 330 is disposed in a center of the square.

When a length of the first electrode 320 (corresponding to a base portion among the first electrodes 320 and 325, hereinafter referred to as “a base portion 320 of the first electrodes”) extended in the X-axis direction, which is measured in the Y-axis direction, is designated by a width of the first electrode, and a length of the second electrode 330 extended in the Y-axis direction, which is measured in the X-axis direction, is designated by a width of the second electrode 330, the width of the first electrode may be equal to or smaller than the width of the second electrode. In the case in which the width of the first electrode to which a driving voltage is applied is small, an intersecting area of the first electrode and the second electrode is decreased, and thus, capacitance between the electrodes intersecting each other is reduced, so that a gap between the first electrode and the second electrode may be decreased. Therefore, a two-layer structured touchscreen panel can be advantageously slimmed.

The touchscreen panel may include a plurality of unit sensing cells 310. Among the plurality of unit sensing cells 310, the first electrodes 320 and 325 and the second electrode 330 included in one unit sensing cell 310 may be connected to the first electrodes 320 and 325 and the second electrode 330 included in another unit sensing cell 310 adjacent thereto.

The first electrode 325 included in the unit sensing cell 310 may corresponds to branch portions, and the branch portions 325 of the unit sensing cell 310 are extended from the center of the square in which the base portion 320 of the first electrodes and the second electrode 330 intersect each other, in diagonal directions. The branch portions 325 may be symmetrical to each other with respect to an X-axis and a Y-axis, centered on the intersection between the base portion 320 of the first electrodes and the second electrode 320. The branch portions 325 included in one unit sensing cell 310 may not be connected to the branch portions 325 of another unit sensing cell 310 adjacent thereto.

In the branch portions 325 extended from the center of the square of the unit sensing cell 310 in the diagonal directions, one end of each of the branch portions, disposed far from the center of the square may be parallel with the second electrode 330. Electric field is formed between the second electrode 330 and the branch portion 325 of the first electrode as well as between the second electrode 330 and the base portion 320 of the first electrode, and thus the changes in capacitance due to the touch input can be increased. That is, the width of the first electrode is made small and thus capacitance before the touch input may be small, but the changes in capacitance may be increased by forming the branch portions 325 in the first electrode, so that the rate of change in capacitance may be increased at the time of the touch input. Therefore, there can be provided a touchscreen panel capable of being slimmed and sensing the touch input at high accuracy.

In addition, the unit sensing cell includes a portion of a third electrode 340. The third electrode 340 may be formed between one first electrode and another first electrode adjacent thereto among the plurality of first electrodes such that the third electrode 340 may interlock with the shape of the first electrodes 320 and 325, and may be connected to a ground terminal. According to the present invention, the third electrode 340 is formed between the plurality of first electrodes 320 and 325, to decrease an exposed area of the second electrode 330, exposed to an LCD provided under the first electrodes 320 and 325 in the touchscreen device, whereby a noise shielding effect may be obtained.

That is, according to the present invention, there can be provided a touchscreen panel having high accuracy in determining the touch input and a small thickness.

FIG. 4 is a view for illustrating an operation of the touchscreen device according to the embodiment of the present invention.

Referring to FIG. 4, in the case in which a conductive rod or a stylus pen is used for a touch input, instead of using a finger, the contact area of a panel by the touch input may be decreased.

In addition, since the width of the first electrode is decreased, the possibility that the third electrode connected to the ground terminal is touch-inputted may be increased.

For example, when a touch input region 440 touched by a conductive rod having a small diameter is located between a base portion 420 of first electrodes and a second electrode 430, changes in capacitance due to a touch input can be largely increased due to branch portions 425 extended from the base portion 420 of the first electrodes, and coupling field generated in a boundary between adjacent unit sensing cells can be reduced. Therefore, a recognition rate of the touch input by the conductive rod having a small diameter can be improved.

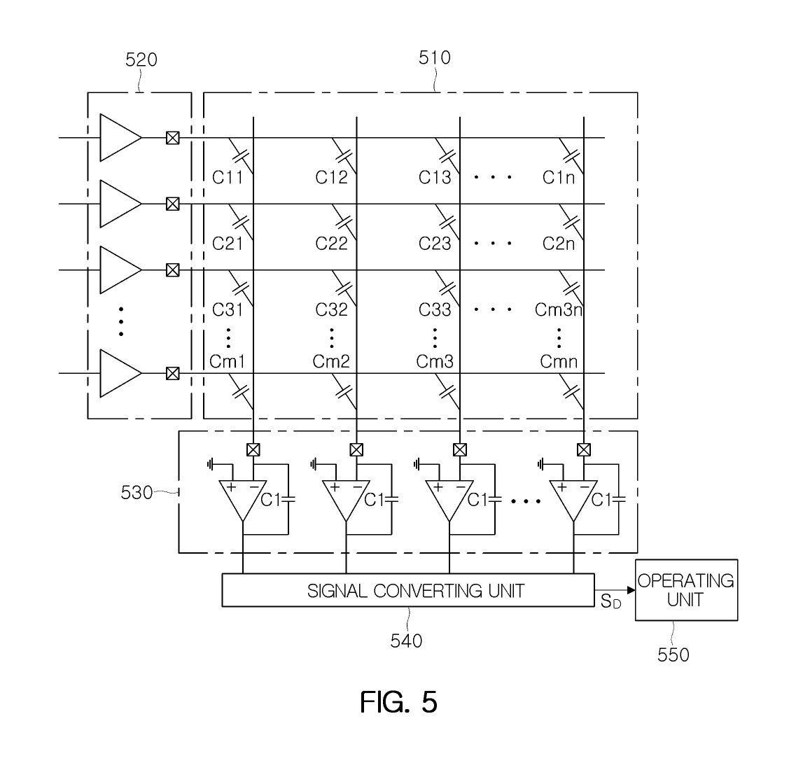

FIG. 5 is a schematic diagram showing the touchscreen device according to the embodiment of the present invention.

Referring to FIG. 5, a touch sensing device according to the present embodiment may include a panel unit 510, a driving circuit unit 520, a sensing circuit unit 530, a signal converting unit 540, and an operating unit 550. The panel unit 510 may include a plurality of first electrodes extended in a first axis direction—that is, a horizontal direction in FIG. 5, and a plurality of second electrodes extended in a second axis direction that crosses the first axis direction, that is, a vertical direction in FIG. 5. The changes in capacitance C11 to Cmn generated in the intersections between the first electrodes and the second electrodes may be changes in mutual-capacitance generated by driving signals that are applied to the first electrodes from the driving circuit unit the 520. Meanwhile, the driving circuit unit 520, the sensing circuit unit 530, the signal converting unit 540, and the operating unit 550 may be realized as a single integrated circuit (IC).

The driving circuit unit 520 may apply predetermined driving signals to the first electrodes of the panel unit 510. The driving signals may include a square wave signal, a sine wave signal, a triangle wave signal, and the like, which have a predetermined cycle and amplitude, and may be sequentially applied to the first electrodes. FIG. 5 illustrates that circuits for applying driving signals are individually connected to the first electrodes. However, alternatively, a single driving signal generating circuit may be provided and driving signals may be applied to the respective first electrodes by using a switching circuit.

The sensing circuit unit 530 may include an integration circuit for sensing the changes in capacitance C11 to Cmn from the second electrodes. The integration circuit may include at least one operational amplifier and a capacitor C1 having a predetermined capacitance. An inverting input terminal of the at least one operational amplifier is connected to the second electrodes, and thus, the changes in capacitance C11 to Cmn are converted into an analog signal such as a voltage signal or the like to be output. When driving signals are sequentially applied to the first electrodes, since changes in capacitance C11 to Cmn from the second electrodes may be simultaneously detected, the integration circuit may be provided in an amount equal to the number (i.e., m) of second electrodes.

The signal converting unit 540 generates a digital signal S_{D} from the analog signal generated by the integration circuit. For example, the signal converting unit 540 may include a time-to-digital converter (TDC) circuit for measuring a period of time for which an analog signal output in the form of voltage from the sensing circuit unit 530 reaches a predetermined reference voltage level and converting the period of time into the digital signal S_{D} or an analog-to-digital converter (ADC) circuit for measuring an amount by which a level of the analog signal output from the sensing circuit unit 530 is changed for a predetermined period of time and converting the amount into the digital signal S_{D}. The operating unit 550 determines a touch input applied to the panel unit 510 by using the digital signal S_{D}. For example, the number of touch inputs applied to the panel unit 510, coordinates of the touch input, a gesture based on the touch input, or the like.

As set forth above, according to the embodiments of the present invention, in order to improve the recognition rate of a touch input region having a small diameter by realizing the slimming of a device while having an increased rate of change in capacitance, the width of the first electrode having a predetermined repetitive pattern may be formed to be equal to or smaller than the width of the second electrode and the branch portions are formed to be extended from the intersection of the first electrode and the second electrode in diagonal directions.

While the present invention has been shown and described in connection with the embodiments, it will be apparent to those skilled in the art that modifications and variations can be made without departing from the spirit and scope of the invention as defined by the appended claims.

What is claimed is:

1. A touchscreen panel, comprising:
a plurality of first electrodes each including a base portion extended in a first axis direction and one or more branch portions connected to the base portion; and
a plurality of second electrodes each extended in a second axis direction intersecting the first axis direction,
wherein the branch portions are extended from an intersection between the base portion of the first electrode and the second electrode.

2. The touchscreen panel of claim 1, further comprising a third electrode formed between one first electrode and another first electrode adjacent thereto among the plurality of first electrodes, the third electrode being grounded.

3. The touchscreen panel of claim 1, wherein a portion of the first electrode and a portion of the second electrode are included in a single unit sensing cell being square, and the branch portions included in the unit sensing cell are extended in diagonal directions in the unit sensing cell.

4. The touchscreen panel of claim 3, wherein the branch portions included in the unit sensing cell, are spaced apart from branch portions included in another unit sensing cell adjacent to the unit sensing cell.

5. The touchscreen panel of claim 1, wherein the branch portions are symmetrical to each other with respect to the first axis direction and the second axis direction, centered on the intersection between the first electrode and the second electrode.

6. The touchscreen panel of claim 1, wherein distal ends of the branch portions are parallel with the first axis direction and the second axis direction.

7. The touchscreen panel of claim 1, wherein the base portion of the first electrode has a width equal to or less than that of the second electrode.

8. The touchscreen panel of claim 1, further comprising an operating unit determining a touch input by sequentially applying predetermined driving signals to the plurality of respective first electrodes and detecting changes in capacitance from the plurality of second electrodes intersecting the first electrodes to which the driving signals are applied.

9. A touchscreen device, comprising:
a panel unit including a plurality of first electrodes each extended in a first axis direction and a plurality of second electrodes each extended in a second axis direction intersecting the first axis direction; and
an operating unit electrically connected to the plurality of first electrodes and the plurality of second electrodes to determine a touch input,
wherein the first electrode includes a base portion extended in the first axis direction and branch portions connected to the base portion, and
the branch portions are extended from an intersection between the base portion of the first electrode and the second electrode.

10. The touchscreen device of claim 9, wherein the panel unit includes a plurality of unit sensing cells each being square and including the first electrode the second electrode intersecting each other at a center of the square.

11. The touchscreen device of claim 10, wherein the first electrode and the second electrode included in one unit sensing cell are connected to the first electrode and the second electrode included in another unit sensing cell adjacent thereto among the plurality of unit sensing cells.

12. The touchscreen device of claim 10, wherein the branch portions of the first electrode included in the unit sensing cell are extended from the center of the square in diagonal directions.

13. The touchscreen device of claim 10, wherein the branch portions are symmetrical to each other with respect to the first axis direction and the second axis direction, centered on the center of the square.

14. The touchscreen device of claim 12, wherein distal ends of the branch portions extended from the center of the square in the diagonal directions are parallel with the second electrode.

15. The touchscreen device of claim 9, wherein the operating unit determines a touch input by applying a predetermined driving signal to the first electrodes and detecting changes in capacitance from the second electrodes.

16. The touchscreen device of claim 15, wherein the operating unit determines at least one of coordinates of the touch input, a gesture motion due to the touch input, and the number of touch inputs.

17. The touchscreen device of claim 9, wherein the panel unit further includes a third electrode formed between one first electrode and another first electrode adjacent thereto among the plurality of first electrodes, the third electrode being grounded.
